(19) United States
(12) Patent Application Publication
(10) Pub. No.: US 2006/0281420 A1
(43) Pub. Date: Dec. 14, 2006

(54) Emergency Mobile Radio Telephone with Reduced Key Set

(76) Inventors: Philip Bernard Wesby, Tiddington (GB); Eveline Wesby Van Swaay, Tiddington (GB); Rauli Parkkali, Helsinki (FI); Hans Kjell Olof Ahnlund, Helsinki (FI)

Correspondence Address: BROMBERG & SUNSTEIN LLP, 125 SUMMER STREET, BOSTON, MA, 02110-1618, US

(21) Appl. No.: 11/465,507

(22) Filed: Aug. 18, 2006

Related U.S. Application Data
(63) Continuation of application No. 10/742,518, filed on Dec. 19, 2003.
Application No. 10/742,518 is a continuation of application No. 09/508,223, filed on Jun. 1, 2000, now abandoned.

(30) Foreign Application Priority Data
Sep. 9, 1997 (FI) 973637

(51) Int. Cl. H04B 1/38

(52) U.S. Cl. 455/90.2

(57) ABSTRACT

A mobile radio telephone or portable hot link communicator is described which provides a simple, efficient and effective means of communication to enable a child or elderly person to communicate with a known parent, relative or friend carrying a standard mobile telephone. The hot-link communicator is wrist worn or hangs from a cord around the wearer's neck. The hot-link communicator is comprises a preprogrammed module that links it with preferably only one other mobile or fixed telephone. The hot-link communicator comprises very basic functionality and, in some embodiments, no display—only a preprogrammed dialing button and an answer button. The hot-link communicator makes possible communication between parents needing to communicate with their children and between supervising adults and elderly persons needing assistance in that the children and elderly persons do not need to input number in sequence via a key pad or search for a telephone in the rain and dark.

### CROSS REFERENCE TO RELATED APPLICATIONS

This application is a continuation of U.S. patent application Ser. No. 10/742,518 filed Dec. 19, 2003, which is a continuation of U.S. patent application Ser. No. 09/508,223 filed Jun. 1, 2000.

U.S. Patent application Ser. No. 09/508,223 is a national phase application pursuant to 35 U.S.C. §371 and claims the priority benefit of Patent Cooperation treaty application number PCT/GB98/02715 entitled “Emergency Mobile Radio Telephone with Reduce Key Set” filed Sep. 9, 1998.

Patent Cooperation Treaty application number PCT/GB98/02715 is an international application and claims the priority benefit of Finnish patent application number 973637 filed Sep. 9, 1997.

The disclosures of these applications are incorporated herein by reference.

### TECHNICAL FIELD AND BACKGROUND ART

1. Field of the Invention

This invention relates to a portable communicating apparatus. More particularly, it relates to a portable communicating hot link apparatus which can provide a simple, efficient and effective, means of communication between children and their parents, between elderly persons and caring relatives and between mentally less-able individuals and supervising adults.

Children often disappear from view from parents causing anxiety and worry until their whereabouts are known again. Mobile telephone technology, such as GSM, DCS, and CSMA can provide an essential link between older children and their parents but this is not the answer for younger children, elderly persons or mentally less-able individuals. The mobile telephone is very valuable and might easily be lost or stolen from a child or from a mentally less-able individual. Similarly, elderly citizens may experience distress should they become lost in a crowd or lose sight of a supervising adult. In all these instances, children, mentally less-able individuals and elderly persons would quite likely experience difficulty in pressing the right sequence of keys on the mobile telephone, particularly if it were dark or in instances of bad weather.

Elderly persons often make appointments to meet supervising adults, such as their grown up children, but due to the fast commotion of life, they may miss the particular agreed meeting point or they may forget the time of the meeting. There is clearly a need for a communicating device which can address the communication technology requirements of this situation.

2. Description of the Related Art

Current mobile phone technology products do not offer a very simple and cheap technology solution which addresses this essential one-to-one communication need.

In addition to these specific communication problem needs, there is a growing concern about the potentially harmful effect of electromagnetic radiation upon the developing brains of young children. Within this context, there is an opportunity to design a communication device for children which positions the radiating electromagnetic field of a communication device away from the close proximity of the brain. In this regard, parents who maintain the belief that mobile telephones present a health risk due to the radiating antenna may rest secure in the knowledge that this risk can be significantly reduced.

Further to these limitations of existing technologies, and so far as is known, no portable communication apparatus is presently available which serves to offer a hot link communicator comprising the minimum mobile telephone functionality suited to the specific needs of this problem area.

### SUMMARY OF THE INVENTION

the present invention to provides a novel portable hot link communicating apparatus to meet the minimum specific requirements of parents wishing to have facility of immediate communication with their children, between mentally less-able individuals and supervising adults and between elderly persons and caring relatives.

The present invention also provides a novel portable hot link communicating apparatus which comprises a preprogrammed identify module comprising the number of the mobile or fixed telephone to which the hot link communicating device is linked.

The present invention also provides a novel portable hot link communicating apparatus which may comprise no key pad at all, other than a simple array of press pads to initiate a call or to answer an incoming call thereby minimizing cost and functionality of the said communication apparatus.

The present invention also provides a novel portable hot link communicating apparatus which may comprise no display thereby minimizing cost and functionality of the said communication apparatus.

The present invention provides a novel portable hot link communicating apparatus which comprises a simple and effective way of attaching it to the wearer such as a wrist strap, a hip belt clip or a neck cord. In this context, the invention provides a portable hot link communicating apparatus which may function effectively while worn on the wrist such that the electromagnetic field of the radiating antenna is positioned away from the close proximity of the developing brains of young children while a call is in progress.

The present invention provides a novel portable hot link communicating apparatus which may be molded in any of a number of bright colors and designs which are attractive to young children and which are therefore readily worn by said children.

The present invention provides a novel portable hot link communicating apparatus which makes use of state of the art battery technology such that the hot link communicating device may be powered by a light-weight, low volume rechargeable battery with sufficient power to remain active for 24 hours.

The present invention offers these benefits through the provision of a novel portable communicating apparatus or hot link communicator which serves to address the diverse requirements of communication between parents and children, between supervising adults and mentally less-able individuals and between elderly persons and caring relatives.

The hot link communicator preferably comprises a basic mobile telephone circuit having no key pad or display and a rechargeable battery and antenna and a preprogrammed identity module linking it to a single mobile or fixed telephone. Where appropriate, in an alternative embodiment the hot link communicator is able to place a call to one of a plurality of separate telephone numbers comprising mobile telephones, fixed telephones or other hot link communicators. In one embodiment in which the hot link communicator is able to select one of two numbers, an additional separate call button is provided for this purpose. In an alternative embodiment, selection of one of a plurality of numbers is done using the single call initiate button and by sequentially stepping through the numbers stored in the preprogrammed identity module. The indication of which number is being selected can be shown on the screen of the hot link communicator in a number of embodiments; alternatively one of a number of colored lights may be programmed to light up to avoid the expense of the screen.

The hot link communicator works identically as a mobile telephone when it is active and receives a call. It differs from the complexity of a mobile telephone in that comprises no key pad, and in its place, it comprises the circuitry to dial a number preprogrammed into its identity module.

The linked mobile telephone, or any mobile telephone comprising the same type of identity module is thus easily employed to preprogram the unique number of any mobile or fixed telephone to which the hot link communicator is to be linked. This programming feature offers a significant degree in freedom in linking any particular hot link communicator with any particular mobile or fixed telephone. Furthermore, the same method may be employed to program two identity modules and thereby link two hot link communicators to each other.

Other objects and features of the present invention will become apparent from the following detailed description considered in connection with the accompanying drawings which disclose one embodiment of the invention. It is to be understood, however, that the drawings are designed for the purpose of illustration only and that the particular description of the portable hot link communicating apparatus is given by way of example only and does not limit the scope of the invention.

### BRIEF DESCRIPTION OF THE DRAWINGS

FIG. 1 is an illustration of one embodiment of the portable hot link communicating apparatus.

FIG. 2 is an illustration of the use of the hot link communicator within the context of the mobile telephone network.

FIG. 3 is a circuit-block schematic indicating the necessary functional components of the hot link communicating apparatus.

FIG. 4 comprises a schematic of a number of hot link mould shapes that may be used to maximize the acceptability of the product to children and adults.

### DESCRIPTION OF THE PREFERRED EMBODIMENT

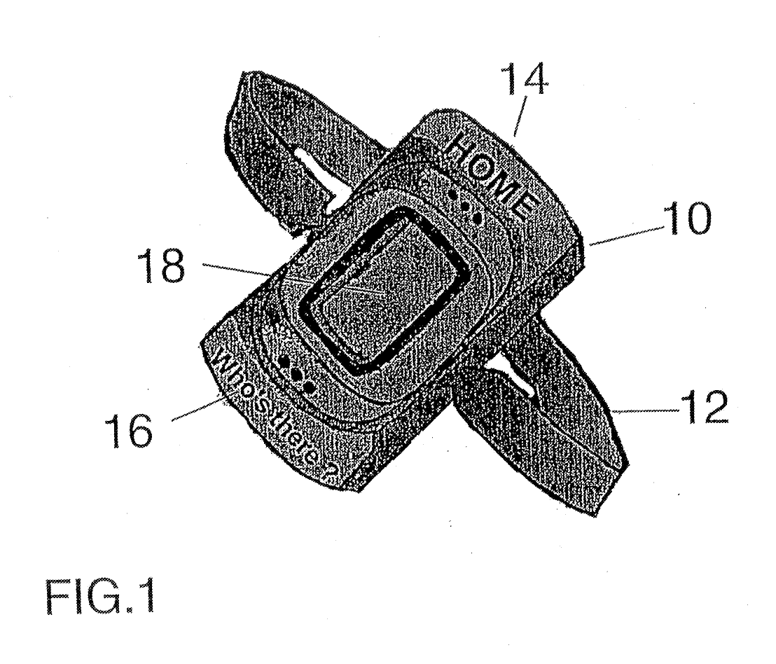

Referring now in detail to the drawings, in particular FIG. 1, therein illustrated is a portable hot link communicating apparatus embodying the present invention.

This device comprises a novel combination of existing technologies and features which make possible the existence of a new and improved portable hot link communicating apparatus to address the needs of parents wishing to have the facility of immediate communication with their children and vice versa, between supervising individuals and mentally less-able persons and between elderly persons and caring relatives.

Furthermore this novel hot link communicator is able to receive and send calls to a preprogrammed mobile or fixed telephone by making use of simplified circuitry to select and call at least one number programmed into the identity module associated with the hot link communicator.

This unique combination of features greatly simplifies the hot link communicator circuitry and thereby reduces the cost of the device.

In a preferred embodiment, the invention is suitably employed within any specific mobile telephone system such as GSM, DCS, and COMA. For the purpose of detailed description and in order to make clear the advantages and benefits of the hot link communicator, particular embodiment of the GSM standard of mobile telephone technology is selected. Furthermore, the corresponding identity module within ,the GMS standard of mobile telephone technology, the subscriber identity module or SIM card is described. This selection of GSM is made by way of example only and does not limit the scope of the invention to the GSM standard since it is obviously and suitably adapted to OCS and COMA telephone technologies by making the corresponding and obvious technical modifications to the hot link communicator circuitry.

In the preferred embodiment, the essential hardware components comprise a basic GMS telephone circuit, a rechargeable battery, a compact GSM antenna, a brightly colored molding—in the instance that it is intended for children—a preprogrammed SIM card and two buttons—one to initiate a telephone call, the other to answer an incoming call—and a ringing tone generator as well as a basic two way microphone device.

With particular reference to FIG. 1 there is shown an illustration of one embodiment of the portable hot link communicating apparatus. The hot link communicator comprises a wrist strap 12, a call button 14 and a call receive button 16. The optional central display 18 may comprise a digital watch and possibly some indication of the coverage level, as is standard in the display of mobile telephones. In a further embodiment the display 18 may indicate who is calling in the instance that this is preprogrammed into the identity module. Furthermore, in a further embodiment, the display 18 can be used to indicate to which one of a plurality of stored telephone numbers the hot link communicator can initiate a call, in which case a particular sequence of key presses can be programmed to step through the list of stored numbers.

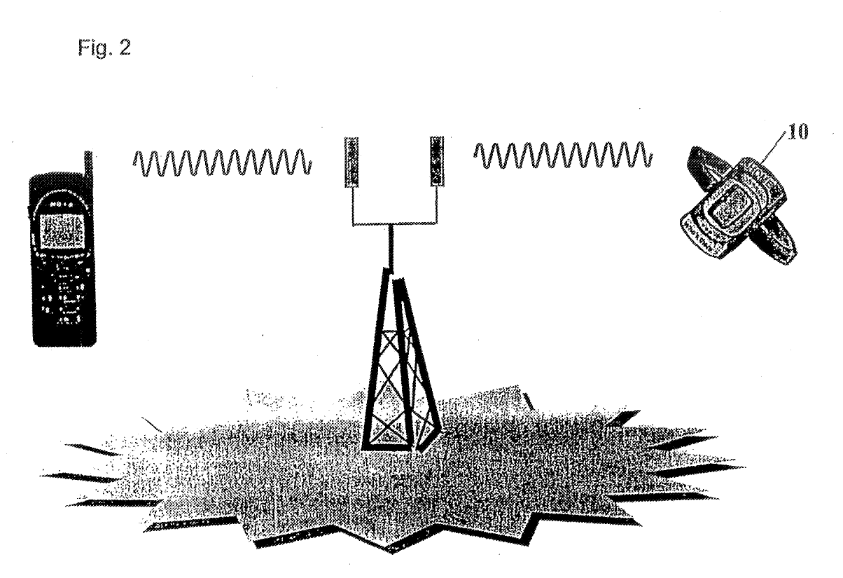

FIG. 2 shows an illustration of the ease of use of the hot link communicator within the context of mobile telephone technology.

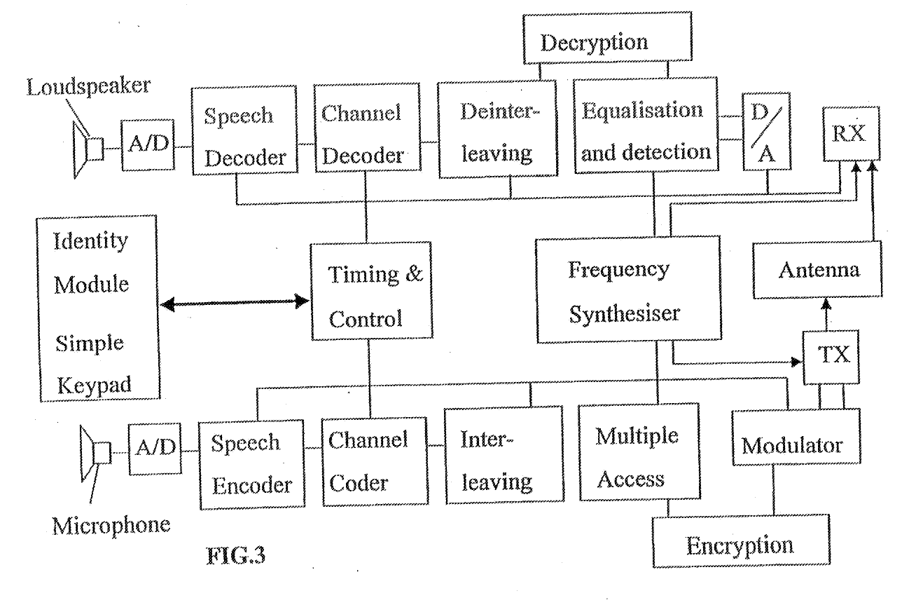

FIG. 3 shows a circuit-block schematic indicating, the necessary functional components of the hot link communicating apparatus according to one embodiment based on the standard schematic for GSM. The hot link communicator differs from the standard GSM telephone circuit in that the circuit has no keypad for entering numbers and in its place it makes use of a simplified button for automatically calling a number in the preprogrammed Identity Module.

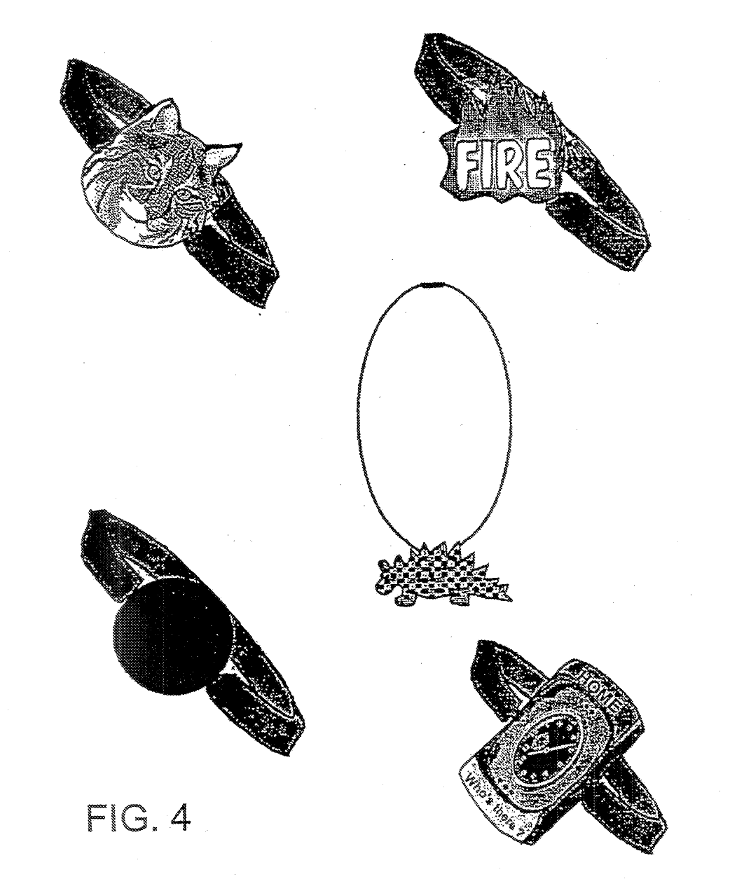

FIG. 4 shows a number of possible shapes of the hot link communicator into which the plastic housing could be molded to make the communicator most acceptable to children.

The hot link communicator is intended to provide an emergency telephone connection using the simplest combination of technologies in a new and unique way. It is intended that the hot link communicator may contain levels of sophistication to suit different specific needs of individuals. As has been stated before, the hot link communicator may comprise a screen display. In addition, the hot link communicator may comprise the capability to initiate telephone calls to one of a number of telephone numbers stored in the preprogrammed identity module. In GSM this preprogrammed identity module is described as the SIM card or Subscribers Identity Module. Nevertheless, the SIM card is only mentioned by way of example and the invention is not limited to this particular module and any circuitry may be devised to achieve the necessary functionality of the hot link communicator preprogrammed identity module.

In one alternative embodiment, the hot link communicator is able to select one of a plurality of numbers stored in the preprogrammed identity module. This can be realized in a number of ways such as programming the call initiate button to toggle through the list of stored numbers wherein each is sequentially displayed on the screen. Alternatively, a number of colored lights may be used to indicate from whom a call is being received or to whom a call is about to be initiated wherein one particular colored light corresponds to a particular telephone number stored on the preprogrammed identity module. The use of colored lights may serve to be advantageous when the hot link communicator is to be used by a young child who is unable to recognized alphanumeric text on a screen display.

While only one embodiment of the present intention, the hot link communicator within the context of the digital GSM telephone system in particular, has been shown and described in detail, it will be obvious to those persons of ordinary skill in the art, that many changes and modifications may be made there unto without departing from the spirit of the invention, for example, the hot link communicator may make use of any telephone technology such as CDMA and DCS. Furthermore the hot link communicator may be stored in a battery recharging device when not worn such that it remains available for use when needed.

What is claimed is:

1. A wireless communication device including a digital mobile telephone circuit, a rechargeable battery, a compact antenna, a ringing tone generator, a basic two-way microphone device for providing the facility of immediate communication or emergency telephone connection, comprising:
a simplified array of press pads to initiate a preprogrammed unique subscriber telephone number and to answer an incoming call; and
a programmable identity module storing at least one unique subscriber telephone number wherein at least one button of said simple array of press pads automatically initiates a call of a unique subscriber telephone number from said preprogrammed identity module and wherein said programmable identity module is adapted to be preprogrammed remotely by another mobile phone linked by radio path.

2. A wireless communication device according to claim 1 wherein said unique subscriber telephone number corresponds to another wireless communication device according to claim 1.

3. A wireless communication device according to claim 1 for use in a mobile telephone system wherein said mobile telephone system being the Global System for Mobile telecommunication (GSM) or is a Code Division Multiple Access system (CDMA).

4. A wireless communication device according to claim 1 wherein said programmable identity module is a Subscriber Identity Module (SIM).

5. A wireless communication device according to claim 1 wherein said simplified array of press pads comprises only two buttons,
a first button to initiate a call of a pre-programmed number from said identity module comprising a unique subscriber telephone number; and
a second button to answer an incoming call.

6. A wireless communication device according to claim 1 comprising a screen display.

7. A wireless communication device according to claim 6 wherein said screen display further comprises a digital watch and/or some indications of the coverage level.

8. A wireless communication device according to claim 6 wherein a particular sequence of key presses are programmed to step in the list of said stored pre-programmed unique subscriber telephone numbers or
the call initiate button is programmed to toggle through the list of stored pre-programmed unique subscriber telephone numbers.

9. A wireless communication device according to claim 8 further comprising coloured lights.

10. A wireless communication device according to claim 9 further comprising a brightly coloured moulding and/or a wrist strap or a neck strap or a belt clip.

11. A method for initiating a call from a portable hot link communicator comprising a digital mobile telephone circuit, a rechargeable battery, a compact antenna, a ringing tone generator, a basic two-way microphone device for providing the facility of immediate communication or emergency telephone connection, a simplified array of press pads to initiate a pre-programmed unique subscriber telephone number and to answer an incoming call, a programmable identity module storing at least one unique subscriber telephone number wherein at least one button of said simplified array of press pads automatically initiates a call of a unique subscriber telephone number from said pre-programmed identity module, the method comprising the step of:
pre-programming said programmable identity module with said at least one unique subscriber telephone number by means of any mobile telephone linked over a radio path comprising the same type of identity module in order to link said portable hot link communicator to any particular mobile or fixed telephone.

12. The method for initiating a call from a portable hot link communicator in a telephone system according to claim 11 wherein said telephone system is GSM and said Programmable Identity Module is a Subscriber Identity Module (SIM).

13. The method for initiating a call from a portable hot link communicator in a telephone system according to claim 12 wherein said programmable identification module is pre-programmable by a linked mobile phone comprising the same type of Subscriber Identification Module.

14. The method for initiating a call from a portable hot link communicator in a telephone system according to claim 13 further comprising the steps of:
selecting a button from said simplified array of press pads,
pressing said selected button in order to initiate a call of a unique preprogrammed number from said Programmable identity Module.

15. The method for initiating a call from a portable hot link communicator in a telephone system according to claim 13 further comprising the steps of:
selecting a specific button from said simplified array of press pads,
pressing said selected button in order to display a stored pre-programmed unique subscriber telephone number on a screen display,
stepping in the list of said stored pre-programmed unique subscriber telephone numbers by repeatedly pressing said specific button,
selecting one of said numbers from said list, and
maintaining pressed said button or another button from said simplified array of press pad for a few seconds in order to initiate the call of said unique stored pre-programmed number from said Programmable Identity Module.

16. The method for initiating a call from a portable hot link communicator in a telephone system according to claim 15 further comprising the steps of:
switching or flashing on a coloured light from at least one of a number of coloured lights corresponding to said unique telephone number.

17. A method for answering an incoming call at a portable hot link communicator comprising a digital mobile telephone circuit, a rechargeable battery, a compact antenna, a ringing tone generator, a basic two-way microphone device for providing the facility of immediate communication or emergency telephone connection, a simplified array of press pads to initiate a pre-programmed unique subscriber telephone number and to answer an incoming call from a pre-programmed unique subscriber telephone number, a programmable identity module storing at least one unique subscriber telephone number wherein at least one button of said simplified array of press pads automatically initiates a call of a unique subscriber telephone number from said pre-programmed identity module the method comprising the steps of:
pre-programming said programmable identity module with said at least one unique subscriber telephone number by means of any mobile telephone linked over a radio path comprising the same type of identity module in order to link said portable hot link communicator to any particular mobile or fixed telephone.

18. The method for answering an incoming call at a portable hot link communicator in a telephone system according to claim 17 wherein said telephone system is GSM and said Programmable Identity Module is a Subscriber Identity Module (SIM).

19. The method for answering an incoming call at a portable hot link communicator according to claim 17 further comprising the steps of: indicating that call is coming by the ringing tone generator of said portable hot link communicator,
pressing a specific button from said simplified array of press pads, communicating through said two-way microphone device.

20. The method for answering an incoming call at a portable hot link communicator according to claim 19 wherein the step of indicating a call includes:
switching or flashing on a coloured light from at least one of a number of coloured lights corresponding to said received telephone call.

21. The method for answering an incoming call at a portable hot link communicator according, to claim 19 further comprising the step of:
displaying which one of a plurality of said stored pre-programmed unique subscriber telephone numbers is calling on a screen display.
